(19) United States
(12) Patent Application Publication
(10) Pub. No.: US 2010/0173615 A1
(43) Pub. Date: Jul. 8, 2010

(54) Locating Lost Cell Phones

(75) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(73) Assignee: HARRIS TECHNOLOGY, LLC, Rancho Santa Fe, CA (US)

(21) Appl. No.: 12/348,287

(22) Filed: Jan. 3, 2009

(51) Int. Cl. H04M 3/42; H04W 24/00; H04M 1/66

(52) U.S. Cl. 455/414.1; 455/456.2; 455/457; 455/411; 340/539.32

(57) ABSTRACT

A phone sends information about its whereabouts periodically to a receiving part. The receiving part can then report the last location or information about the last known location of the phone. The query can return a map of both coarse and fine. This allows determining the location of the phone, even when the phone is off or not receiving cell service. A special message can be to the phone, indicating that the phone is trying to be found. This puts the phone into an “im lost” mode, from which it does not recover until a code is entered.

### BACKGROUND

As cell phones get smaller, it becomes easier to lose them. However, it is desirable for the cell phone to be small so that it can be easily carried by a user between different places. The small cell phone, which is desirable in so many other ways, is easy to put down and forget, easier to fall out of a pocket and just in general easier to lose. Users often lose their cell phones and have no way of finding them.

One way of finding a cell phone have lost is to call its number and listen for the ring.

### SUMMARY

The inventor noticed, however, that calling a cell phone to find the cell phone is inherently a flawed way to find such a cell phone. Sometimes the phone is under something and it may be difficult or impossible to hear its ring. Sometimes the cell phone, especially when under something, is outside of cell server. The phone may have a depleted battery. The phone may be in a place where you can't hear it at all.

Moreover, as phones become more sophisticated and smaller, it becomes progressively more difficult to find these phones when they are lost.

According to an embodiment, a cellular phone location device is defined which allows users to find cellular phones that have been lost.

An embodiment describes a phone that sends information about its whereabouts periodically to a receiving part. The receiving part can then report the last location or information about the last known location of the phone.

### BRIEF DESCRIPTION OF THE DRAWINGS

FIG. 1 shows a block diagram of the system; and

FIG. 2 shows a flowchart of operation.

### DETAILED DESCRIPTION

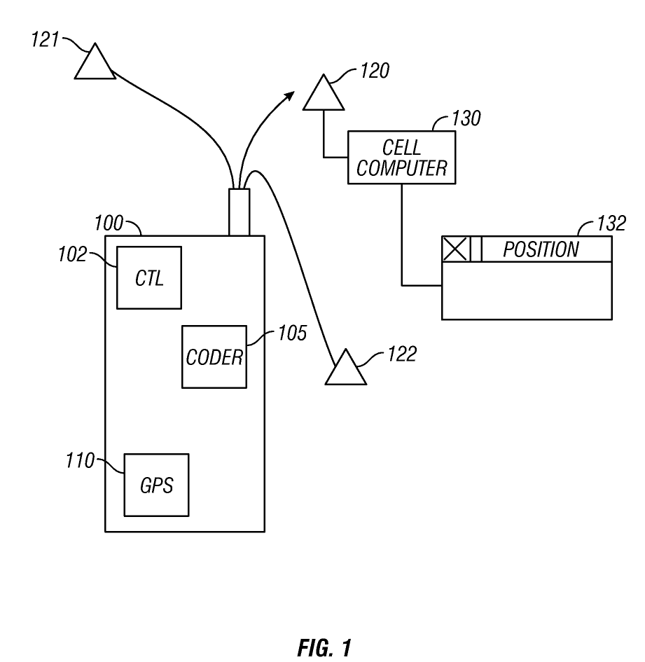

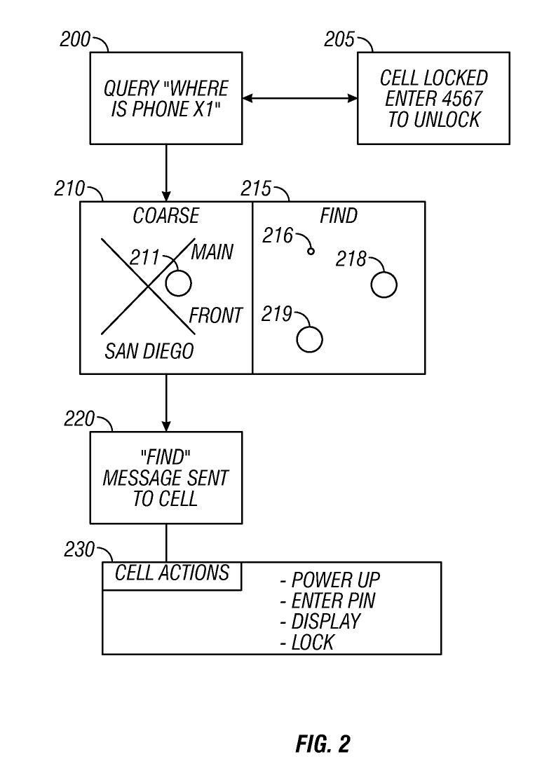

An embodiment is shown in FIG. 1. A cell phone 100 includes communication circuitry therein shown generally as 105. The communication circuitry sends information to local cell towers, including any kind of information from the phone. The phone can also include a GPS device 110 that reports its location. However, the GPS device may be able to obtain accurate location information when having reception of multiple satellites—typically not indoor. A controller 102 controls the operation of the phone based on input commands and as shown in the flowchart of FIG. 2.

According to an embodiment, the communication device 105 communicates with a number of different cell towers shown as 120, 121, 122. However, only the closest cell tower 120 is the selected cell tower; all the others are deselected. However, the act of communicating infers that either the communication device 105, or a cellular system computer shown generally as 130, knows the identity of those cell towers 120, 121, 122 that are communicating with the cellular phone. The cellular computer 130 stores for each of a plurality of cellular phones (e.g. phone 100 which is shown as X1), a position file shown as 132 which represents the position information of the cellular phone as last received.

The position information can be the GPS coordinates of the last time that accurate GPS coordinates were obtained. The position information can also include a triangulation between the signals sent and received by towers 120, 121 and 122. The position information 132 can be received from the phone.

In an embodiment, the communication device 105 may include a processor or digital signal processor and/or may include an FPGA. This processing capability may determine information about the phone's location based on parameters such as triangulation and GPS.

When sending pilots or other stay alive signals to the towers, the phone 100 may include information about a calculated or estimated position of the phone. As an alternative, the cellular computer 130 may calculate or estimate this position. This information can include information from multiple different sources, as described above.

The position 132 is updated each time a new position is received or each time that information is received from telephone use from which a new position can be obtained,

Information about the latest position of a cell phone is thus obtained and stored at many different times. The storage thus has the phone's most current whereabout.

When a phone is lost, the user can execute the find routine shown in FIG. 2. At 200, the system queries “where is phone X1?”. This query may be done on an Internet website, or may be done on another cellular phone associated with the carrier that runs the computer 130. The query is sent to the computer 130. The last stored location of the phone is returned at 210. In one embodiment, that last stored location is overlaid onto two maps: a coarse map showing street level details and a fine map showing as much detail as possible about the actual location. The coarse map may show a general location of where the phone was last seen as being located. Note that this location may be current, or may be a previous location. The phone location is shown for example on the street. From this, the user may be able to deduce where they left the phone—for example did they leave it in a department store or leave it on a street corner. If the area is near a place the user has visited, e.g. a friend's house etc, the user can deduce where they left the phone.

Note, again, importantly, that this allows determining the location of the phone, even when the phone is off and/or when the phone is not receiving cell service.

The fine map shown as 215 may show details about the last fix shown as 216 relative to known GPS landmarks. For example 216 may be based on a precise GPS location in longitude and latitude. Known longitude and latitude landmarks such as 218 and 219 may also be displayed. Trees, buildings, or other landmarks whose GPS coordinates are known may be included on the map. The fine map may show the last known coordinate relative to these other GPS coordinates. One important displayed landmark may be the user's place of residence and/or work. This can narrow down the search by informing the user that their phone is ‘at home’.

The query causes a message to the now-lost phone indicating that a user is looking for the cell phone at 220.

An embodiment sends a text message as this message to the cell phone.

The message to the cell phone puts the phone into a special find mode at 230, that causes multiple different operations. The find mode may cause for example a periodic power-up mode. The phone increases its transmit power for a short time in order to transmit more assertively during the power up mode. The power up mode may be periodic, e.g., for example, one 2 second period of power up per 5 minutes.

The message to the cell phone may also cause other actions to be taken by the cell. One embodiment initiates a find-me mode on the cell phone, where the cell phone begins audible tones and/or visual displays to enable its easier find. The tones may be loud tone emitted for example every 5 seconds. The displays may be bright alternatives between display on and display off.

The find me mode can also prevent the phone from being used for outgoing calls. This may lock the phone into the find mode until the phone physically has a personal identification code entered. This may be a 4 digit pin. By locking the phone into the find mode, this in essence becomes an anti theft mode where even if the phone is stolen or falls into the wrong hands, it cannot be used for making calls after the loss/theft is reported.

In another embodiment, when entering the query at 200, the user may be required to enter identification which identifies to the system that the user making the query is the authorized user (e.g., the login and password for the user's account on the cellular system). At that point, the phone can be automatically locked down, and the user given a special code that unlocks the locked cell. For example, the user may be given a code in a screen such as shown in 205 which says that “the cell is now locked; enter 4567 on the cell to unlock”. The locked cellular phone therefore cannot be used by anyone who does not know the code. When the user finds their phone, they can enter the number 4567 to unlock it, and resume normal operation. The locking can be carried out, for example, by sending remote signals to the cell phone. These remote signals may be queued in the event of the phone is not currently sending or receiving information.

In the find me mode, the phone becomes useless to a finder who is not the authorized user. In another embodiment, the cell phone may display on its display information about the real owner—such as “call 456-7890 for the authorized user”, or “deliver this lost phone to any VZW store for a $10 reward”, or “drop this in any mailbox to return to the user, postmaster, postage to VZW guaranteed”.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other devices can be controlled in this way. Other forms of code entry can be used. For example, a code can be provided on an external device that can be transferred to the locked unit to unlock it. The find mode can be terminated by entering a code into the same Internet website where the find me mode was initially entered.

Also, the inventor intends that only those claims which use the words “means for” are intended to be interpreted under 35 USC 112, sixth paragraph. Moreover, no limitations from the specification are intended to be read into any claims, unless those limitations are expressly included in the claims.

The computers described herein may be any kind of computer, either general purpose, or some specific purpose computer such as a workstation. The computer may be a special purpose computer such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A cellular telephone comprising:
a cellular communicator; and
a controller for the cellular communicator, controlling the operation of the cellular telephone, said controller detecting a first signal over the cellular communicator, and entering a mode responsive to said first signal where a find mode is entered, which causes the phone to operate in a different way until said find mode is terminated.

2. A telephone as in claim 1, wherein said find mode is terminated by entering a code on the cell phone.

3. A telephone as in claim 1, wherein said first signal is a message addressed to said cellular phone.

4. A telephone as in claim 1, wherein said mode prevents said cellular communicator from carrying out at least one communication mode until said mode is terminated.

5. A telephone as in claim 1, wherein said mode increases a power of the cellular communicator.

6. A telephone as in claim 5, wherein said power of the cellular communicator is periodically increased.

7. A telephone as in claim 1, further comprising a position detecting part, wherein said position detecting part sends information about said position during said mode.

8. A system comprising:
a server computer, running a routine that controls a user entering identification information and entering information that indicates that the user's cellular phone is lost,
said server computer sending a message to the user's cellular phone indicating that the cellular phone is lost, and
said server computer accessing information about a position of the cellular phone, and providing information about said position to the user.

9. A system as in claim 8, wherein said server displaying information about a position of the phone that is from a previous transmission of the phone, not a current transmission of the phone.

10. A system as in claim 8, wherein said information about said position includes a information about both coarse position information and fine position information.

11. A system as in claim 10, wherein said coarse and fine position information includes landmark information.

12. A system as in claim 8, wherein said server computer locks said cellular phone responsive to said message.

13. A system as in claim 12, wherein said server computer provides information to a user about an unlock code that unlocks the locked phone.

14. A method comprising:
storing in a computer, location information for each of a plurality of cellular phones; and
retrieving at least one of said location information for one of said cellular phones at a time when said at least one of said cellular phones is not transmitting location information.

15. A method as in claim 14, further comprising locking of the cellular phone against making calls.

16. A method as in claim 15,further comprising providing an unlock code to a an authorized user.

17. A method as in claim 16, wherein said locking prevents said phone from being used until said unlock code is entered in to said cellular phone.

18. A method as in claim 14, further comprising displaying said location information to a user.

19. A method as in claim 18, further comprising displaying at least one landmark along with said location information.

20. A method as in claim, further comprising commanding the phone to increase its power output
